(19) United States
(12) Patent Application Publication
(10) Pub. No.: US 2010/0031041 A1
(43) Pub. Date: Feb. 4, 2010

(54) Method and system for securing internet communication from hacking attacks

(75) Inventor: Ram Cohen, Tel Aviv (IL)

Correspondence Address: ROBERT G. LEV, 4766 MICHIGAN BLVD., YOUNGSTOWN, OH, 44505, US

(73) Assignee: PostalGuard Ltd., Petah Tikva (IL)

(21) Appl. No.: 12/462,431

(22) Filed: Aug. 3, 2009

Related U.S. Application Data
(60) Provisional application No. 61/085,886, filed on Aug. 4, 2008.

(51) Int. Cl. H04L 9/32

(52) U.S. Cl. 713/168

(57) ABSTRACT

The present invention is directed to a method of authenticating internet communication using at least one reference URL along with associated, approved digital certificates. The method includes the use of a URL verification module for verifying communication from a source URL. Communications from the source URL are intercepted and comparison made with approved digital certificates to determine if communication is authorized.

### PRIORITY INFORMATION

The present invention claims priority to U.S. Provisional Application No. 61/085,886 filed on Aug. 4, 2008, and makes reference herein to same in its entirety.

### FIELD OF THE INVENTION

The present invention relates to the field of internet security. More particularly, the invention relates to a method and system for securing internet communication from man-in-the-middle phishing attacks.

### BACKGROUND OF THE INVENTION

Transmission of encrypted messages between terminals connected to the internet may be susceptible to eavesdropping. In one common hacking scheme, sometimes known as a man-in-the-middle attack, a hacker makes independent connections with each of two internet terminals, for example, with a website belonging to a bank and with a computer terminal belonging to a customer of that bank, establishing a computer therebetween, known henceforth as a man-in-the-middle computer. The man-in-the-middle computer intercepts and relays messages between the two terminals. Each terminal receives messages from the man-in-the-middle which appear to come from the other terminal over a private connection, which may be encrypted, when in reality the communication is controlled and monitored by the man-in-the-middle computer. A hacker may use such a scheme to eavesdrop on the communication and to acquire private information such as credentials, passwords and the like.

Some internet protocols, notably, Transport Layer Security (TLS) and Secure Sockets Layer (SSL), aim to protect against eavesdropping by encrypting message data and by authenticating at least one of the terminals. TLS and SSL use public key cryptography, in which one of the terminals, for example the web server of the bank sends a public key certificate to a remote terminal, say the customer. The public key is a known device which the customer's computer uses to encrypt the data sent to the bank. The encrypted data cannot be decrypted without a private key known only to the bank. In some internet browsers, secure connection with a certified website is indicated to the user by a dedicated icon, such as a lock symbol for example. Seeing such an icon, the customer typically sends sensitive data confidentially, believing that even were the encrypted data to be intercepted it would be undecipherable by any party not having the private key.

It is possible, however, for a man-in-the-middle hacker to set up an independent TLS or SSL connection with an unsuspecting victim. The victim will be able to check that the connection is encrypted, and the victim may believe that because the connection is encrypted, the connection is secure. However, because the public key of the encryption certificate is sent to the user by the man-in-the-middle and not by the desired website, the man-in-the-middle knows the private key. Therefore, even though the data sent by the victim's computer is encrypted, it is encrypted in a way accessible by the man-in-the-middle who has the private key required to decrypt it. Indeed, typically the intended recipient, e.g. the bank, cannot open these themselves without the mediation of the man-in-the-middle.

It is thus advisable for a user of an encrypted internet connection to check that the received public key certificate has a trusted issuer. One way to do this is to use a trusted third party to authenticate the issuer of the public key certificate. Some browsers provide alerts if the issuer of a public key certificate is not authenticated. Nevertheless, users may still accept public key certificates from unauthorized issuers, and in more elaborate phishing schemes the hacker has been known to invent a fictitious trusted third party or even to obtain a trusted certificate from an authenticating organization.

It is also possible for the man-in-the-middle hacker to set up an SSL-TLS connection with the bank site (that demands it) but to set up a clear connection with the victim. Such victims typically do not notice the lack of the secure connection icon in the browser, and continue to apparently access the bank site even though the connection is not encrypted.

A particular target of some hackers is the DNS (Domain Name System) servers which are used to translate a server address to its corresponding IP address. When a user enters a URL into a web browser's address bar, the web browser queries a DNS server to obtain the IP address of the URL address. The DNS server has a cache of URL addresses and corresponding IP (Internet Protocol) addresses. A hacker may abuse the DNS server by a technique known as DNS cache poisoning, in which a hacker edits the cache to redirect a URL to an IP address associated with a phishing website. The phishing website may mimic the desired website thereby luring an unsuspecting user into providing confidential information such as usernames, passwords and the like.

Another form of attack is to send the user an e-mail message, purportedly from the bank that contains a URL and instructions to click it. However, when the user clicks the URL he is connected to the phishing website and not to the bank website.

There is a need, therefore, for more effective systems to protect a user from such hacking scams, and embodiments of the present invention address this need.

### SUMMARY OF THE INVENTION

In a first aspect, the present invention is directed to providing a method for authenticating an internet connection, said method comprising the steps of:
(a) populating a reference database with at least one reference-URL and an associated set of approved digital certificates;
(b) providing a URL verification module for verifying a communication from a source-URL;
(c) intercepting a communication from the source-URL;
(d) comparing the source-URL with the reference-URLs stored in said reference database, and
(e) optionally opening a new connection with the source—(f), such that if said source-URL corresponds to the reference-URL, providing an alert unless either said communication of step (c) or the new connection of step (e) comprises at least one approved digital certificate associated with the reference.

Optionally, the database is populated with a comparison directive associated with the reference URL such that comparison between the source-URL and the reference-URL is in accordance with said directive.

Optionally, the comparison directive is embedded in content referenced by the reference-URL.

In one embodiment, step (a) comprises the sub-steps of:
(a1) receiving a communication comprising at least one digital certificate from a trusted website locatable by a trusted URL;
(a2) storing said trusted URL as a reference-URL in said reference database, and
(a3) adding the received digital certificate to the set of approved digital certificates associated with said trusted URL.

In another embodiment, step (a) comprises importing contents of an external database into said reference database.

In one embodiment, the alert is issued if said communication is no longer protected by a digital certificate.

Optionally, the alert is issued if said communication has a digital certificate issued by a new certification authority that is different from any certification authority that has previously issued one or more digital certificate to the URL.

Typically, the alert is selected from at least one of a group comprising: a visual alert for a user of said internet application; an audio alert to a user of said internet application; an alert issued directly to said internet application; an alert issued directly to a plug-in application to said internet application; an alert issued to a remote internet location, and an alert issued to a representative of a proprietor of said source-URL.

In some embodiments, the URL verification module is selected from at least one of the group comprising: (a) a plug-in to a software application; (b) an add-on software application running on a communication device; (c) a remote application intercepting communication from a communication device, and (d) a software application running on at least one remote device selected from the group comprising: a gateway server, a mail server and a proxy server.

Optionally, the reference database is further limited by at least one characteristic selected from the group comprising: (i) at least one said associated set comprising one approved digital certificate; (ii) said reference database being in communication with a plurality of URL verification modules; (iii) said reference database being editable by a user of a communications device, and (iv) said reference database being editable by representatives of the proprietors of said source-URLs.

Optionally, the digital certificate comprises a public key certificate.

In a second aspect, the present invention is directed to a system for authenticating an internet connection, said system comprising a URL verification module for communicating with a reference database for storing at least one reference-URL and an associated set of approved digital certificates, wherein said verification module provides an alert unless an internet communication received from a source-URL includes at least one digital certificate which is a member of the set of approved digital certificates associated with a reference-URL matching said source-URL.

In some embodiments, the URL verification module is selected from at least one of the group comprising: a plug-in to a software application; an add-on software application running on a communication device; a remote application intercepting communication from a communication device, and a software application running on at least one remote device selected from the group comprising: a gateway server, a mail server and a proxy server.

Optionally the reference database is further limited by at least one restriction selected from the group comprising: (i) at least one said associated set comprising one approved digital certificate; (ii) said reference database being in communication with a plurality of URL verification modules; (iii) said reference database being editable by a user of a communications device, and (iv) said reference database being editable by representatives of the proprietors of said source-URLs.

Optionally, the digital certificate comprises a public key certificate.

Another aspect of the invention is directed to providing a carrier medium carrying computer readable code, said code operable for:

i. intercepting an internet communication from a source-URL;

ii. communicating with a storage medium for storing at least one reference-URL and an associated set of approved digital certificates, and

iii. providing an alert unless the intercepted internet communication comprises at least one digital certificate which is a member of the set of approved digital certificates associated with a reference-URL matching said source-URL.

Typically the code is selected from at least one of the group comprising: (a) a plug-in to a software application; (b) an add-on software application running on a communication device; (c) a remote application intercepting communication from a communication device, and (d) a software application running on at least one remote device selected from the group comprising: a gateway server, a mail server and a proxy server.

Typically the storage medium is further limited by at least one characteristic selected from the group comprising: (a) at least one said associated set comprising one approved digital certificate; (b) said storage medium being in communication with a plurality of carrier media; (c) the contents of said storage medium being editable by at least one communications device, and (d) the contents of said storage medium being editable by representatives of the proprietors of said source-URLs.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 shows a schematic representation of a system for authenticating a secure internet connection according to an exemplary embodiment of the invention accessing a communication from a valid web site;

FIG. 2 shows a schematic representation of the system of the exemplary embodiment of FIG. 1, accessing a website from a phishing web site, and

FIG. 3 is a flowchart of a method for authenticating a secure internet connection according to embodiments of the invention.

### DESCRIPTION OF THE PREFERRED EMBODIMENTS

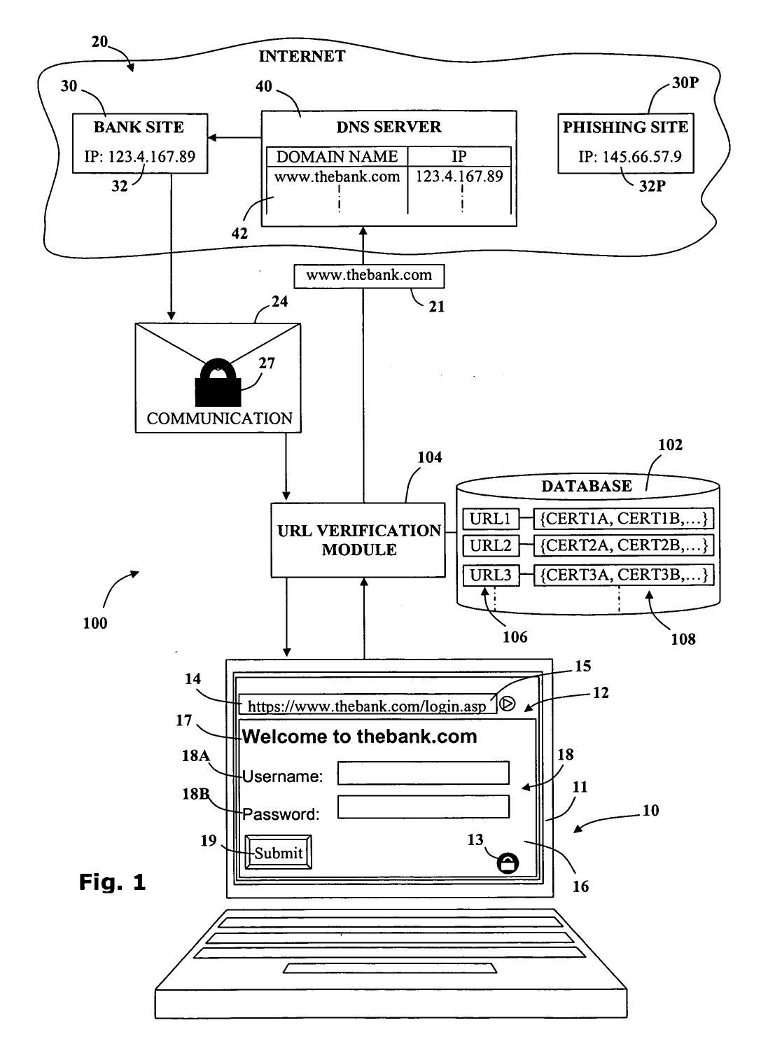

Reference is now made to FIG. 1 showing a schematic representation of an authentication system 100 for a secure internet connection according to an exemplary embodiment of the invention. The system includes a reference database 102 and a URL verification module 104.

The reference database 102 is a storage medium configured to store a plurality of reference-URLs 106. Each reference-URL 106 is paired with an associated set 108 of approved digital certificates.

The URL verification module 104 is configured to record URL requests 21 sent by an internet terminal 10 and to intercept internet communications 24 sent from the internet 20 in response to the URL requests 21 sent to a given source-URL 15. The URL verification module 104 is configured to check whether the intercepted communication 24 is encrypted by a digital certificate 27, and if so to further check whether the digital certificate 27 is a member of the set 108 of approved digital certificates associated with the source-URL 15. This check can be performed by examining the properties of the internet communication 24 or by establishing another connection using another URL request to the source URL 15.

Optionally, the database 102 may be provided as a ‘plug-in’ to the web browser 12. Alternatively, the URL verification module 104 is configured and operable to communicate with a database 102 application stored on a communication device as a separate ‘add-on’ application. Such plug-in or add-on applications may include features allowing code and definitions to be updated remotely. In still other embodiments, the database 102 is remotely supported at some other storage facility, such as a gateway server, a mail server, a proxy server or the like. The URL verification module 104 is able to access the database 102 as necessary. In some embodiments, the database 102 is accessible by multiple applications and/or by multiple communications devices.

Particular reference is made to FIG. 1, wherein the authentication system 100 is represented intercepting an internet communication 24 sent from a valid web site 30 (illustrated as being a bank site, but this is by way of example only) to an internet terminal 10. Although, the internet terminal 10 described herein is a computer executing a web browser 12, it will be appreciated that embodiments of the invention may be adapted to authenticate internet connection with other internet enabled browsers and communication devices such as personal digital assistants (PDAs), media players, televisions, telephones and the like.

The screen 11 of the computer 10 displays the user interface (UI) of the web browser 12, typically including an address field 14 and a viewing pane 16. The browser sends a URL request 21 to the URL 15 (Uniform Resource Locator), which is entered into the address field 14. This URL 15 is referred to herein as the ‘source-URL’.

The server part of the URL request 21 is queried from a DNS (Domain Name System) server 40 which resolves the server name with an IP address 32 associated with the desired website 30 (of the bank, for example). The DNS server 40 operates by comparing the request 21 with the contents of a cache 42 of domain names and their associated IP addresses.

The (bank) site 30 responds to the URL request 21 by sending a communication 24 including a digital certificate 27, typically a public key certificate which the browser 12 uses to encrypt confidential communications sent to the internet 20.

The URL verification module 104 intercepts the communication 24 sent to the computer 10 and communicates with the reference database 102. The URL verification module 104 checks if the source-URL 15 matches one of the reference-URLs 106 stored in the reference database. If the source-URL 15 does match a reference-URL 106 then the URL verification module further checks that the digital certificate 27 is a member of the set 108 of approved digital certificates associated with the source-URL 15. When both these conditions are fulfilled, the communication is relayed to the internet terminal 10.

In the example of FIG. 1A the communication which is relayed to the internet terminal may include the following code:

<html>
<body>
<H1>Welcome to thebank.com</H1>
<Form action=“https://www.thebank.com/loginprocess.asp”
method=“post”>
Username: <input type=“text” name=“user” size=“20”><br>
Password: <input type=“password” name=“password” size=“20”><br>
<input type=“submit” value=“Submit”>
</Form>
</body>
</html>

The resulting visual display, presented in the browser's viewing pane 16, includes: a heading 17, a form 18 consisting of two input boxes 18A and 18B and a ‘SUBMIT’ button 19. When a user clicks on the ‘SUBMIT’ button 19, the text entered into the input boxes 18A, 18B, (e.g. username, password, etc.) is encrypted by the public key 27 and submitted to the internet 20. Note also that an icon 13 appears indicating that the internet connection is a secure SSL or TLS connection encrypted with a digital certificate.

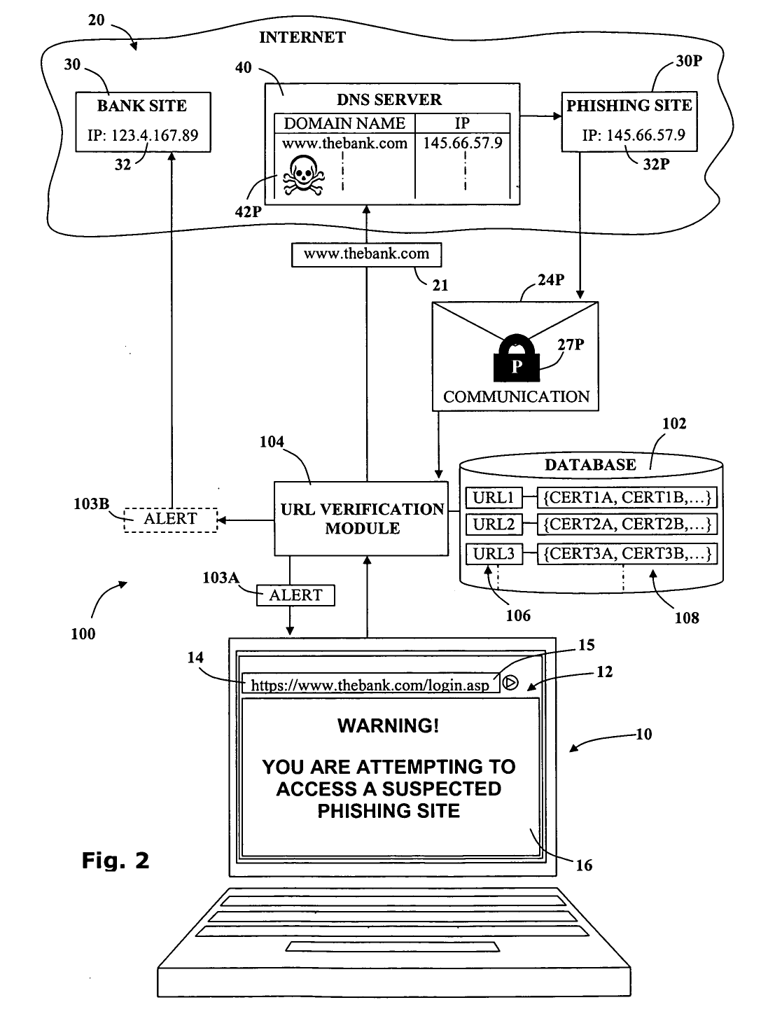

With reference to FIG. 2, the authentication system 100 mutatis mutandis of the exemplary embodiment of FIG. 1 is represented intercepting a phishing internet communication 24P sent to the internet terminal 10 from a phishing web site 30P, such as in scenarios where a hacker is attempting to obtain private information by using a DNS poisoning attack.

The DNS server 40 has been infected by the hacker who has edited the cache 42P so that the domain name www.thebank.com now corresponds to a false IP address associated with a phishing site 30P. When the internet terminal 10 sends a request 21 to the DNS server 40 it is misdirected to the phishing site 30P. Typically, the phishing site 30P sends an internet communication 24P to the internet terminal 10 which mirrors the secure internet communication 24 (FIG. 1A) normally sent by the bank site 30 and which is encrypted with a public key certificate 27P.

Embodiments of the current invention include an authentication system 100 for verifying that the public key certificate 27P matches the Source-URL 15. Consequently, such embodiments of the current invention are able to detect a phishing attack of this type. The phishing communication 24P is intercepted by the URL verification module 104 and when the URL verification module 104 communicates with the reference database 102 it finds an irregularity: although the source-URL 15 matches one of the reference-URLs 106 stored in the reference database, nevertheless the digital certificate 27P is not a member of the set 108 of approved digital certificates associated with the source-URL 15. A warning may be issued to the user for displaying on terminal 10 and/or issued to the trusted site 30, or communication may be cut.

Often the reference-URL 16 is the URL of the bank that is added to the database when user first contacts the bank. In preferred configurations, the source-URL 15 does not need to be an identical match to the URL of the bank, but could be a different page on the same website. Thus the source-URL 15 does not need to be an identical match to the reference-URL 16 to trigger an alarm. However, if a reference URL presents the user with a form that does not have a digital certificate at all, an alarm is generally triggered. Sometimes, only some URLs of a site use encrypted communication (such as the login page, change password page etc.) while the rest of the site uses clear communication. In such cases, the alarm is generally triggered if the unsecure page contains a password entry field or the like. It is also possible for the site to embed markers in the HTML document, perhaps in the form of a comment, a hidden field or the like, to instruct how the URL should be matched to a source URL. For example, a secure login page of an otherwise unsecure site can include an HTML comment that will mark the page as ‘uniquely secured’ and the URL will be stored in the database together with this mark. In such a configuration, when a different, non-secured page from that domain is fetched the alarm is not triggered.

In prior art systems lacking the authentication system 100 of the invention, a browser would receive an unsuspicious internet communication from a valid URL. A user would see a web page identical with the web form 18 shown in FIG. 1 including the security icon 13, or would fail to notice that the channel is not secured. Thus DNS cache poisoning attacks would not typically be detectable. The user clicking on the submit button 19 of the web form would send private information to the phishing site 30P which would be encrypted by a public key certificate 27P to which the hacker has the private key.

Embodiments of the invention prevent this security risk since once an irregularity is detected, the URL verification module 104 is further configured to send a plurality of alerts warning of the attempted phishing scam. A first alert 103A is sent to the internet terminal 10 which may block the construction of the webpage and instead display a warning message in the display pane 16 of the browser 12. Optionally, a second alert 103B may additionally be sent to a representative of the bank to inform the bank site 30 that it is the victim of a phishing attack. It is noted that in preferred embodiments the second alert 103B is sent directly to an IP address thereby bypassing the poisoned DNS server 40.

In various embodiments, alerts may be audio, visual or other sensory alerts provided to inform users of internet applications such as browsers, email clients, chat applications, SMS (Short Message Service) servers and the like, that they may be victims of a phishing attack. Alerts may further be issued directly to plug-in applications of the internet applications or stand-alone applications of a communication device for example. Alerts may be additionally configured to block delivery of suspect communications or the like.

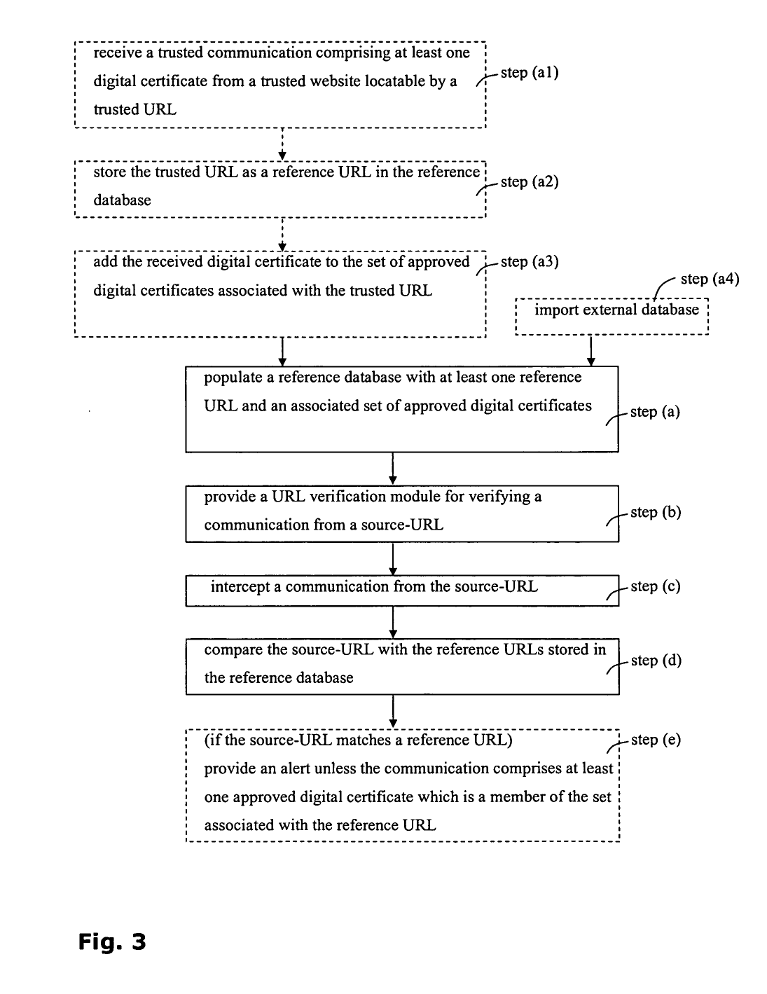

Reference is now made to FIG. 3 showing a flowchart of a method for authenticating a secure internet connection according to embodiments of the invention. The method includes the following steps: step (a)—populating a reference database with at least one reference-URL and an associated set of approved digital certificates; step (b)—providing a URL verification module for verifying a communication from a source-URL; step (c)—intercepting a communication from the source-URL; step (d)—comparing the source-URL with the reference-URLs stored in the reference database, and step (e)—if the source-URL matches a reference-URL, providing an alert unless the communication comprises at least one approved digital certificate which is a member of the set associated with the reference-URL.

According to selected embodiments, the reference database may be populated by the following sub-steps: step (a1)—receiving a trusted communication comprising at least one digital certificate from a trusted website locatable by a trusted URL; step (a2)—storing the trusted URL as a reference-URL in the reference database; and step (a3)—adding the received digital certificate to the set of approved digital certificates associated with the trusted URL.

Alternatively, the reference database may be populated by step (a4)—importing contents of an external database into the reference database. The external database may be stored upon some storage medium such as a DVD, CD, magnetic disk, flash drive, memory stick, hard disk, floppy disk, etc. In other embodiments the external database may be accessible from some remote location, typically accessible via a network such as the internet.

In particular embodiments of the invention, the sets of reference digital certificates include a plurality of nested digital certificates from third-party certification authorities. Typically, according to such embodiments, when an incoming digital certificate is intercepted, all the nested digital certificates of the incoming digital certificate are compared with the members of the set of reference digital certificates associated with the source-URL. Optionally, the URL verification module may be configured to compare only a selection of the nested digital certificates. It is noted that nested digital certificates may correspond to sections of a public key infrastructure or hierarchy.

The scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A method for authenticating an internet connection, said method comprising the steps of:
(a) populating a reference database with at least one reference-URL and an associated set of approved digital certificates;
(b) providing a URL verification module for verifying a communication from a source-URL;
(c) intercepting a communication from the source-URL;
(d) comparing the source-URL with the reference-URLs stored in said reference database, and
(e) optionally opening a new connection with the source and sending a new communication thereby
such that if said source-URL corresponds to the reference-URL,
(f) providing an alert unless
either the communication of step (c) or
the new communication of step (e)
comprises at least one approved digital certificate associated with the reference.

2. The method of claim 1 wherein the database is populated with a comparison directive associated with the reference URL such that comparison between the source-URL and the reference-URL is in accordance with said directive.

3. The method of claim 2 wherein the comparison directive is embedded in content referenced by the reference-URL.

4. The method of claim 1 wherein step (a) comprises the sub-steps of:
(a1) receiving a communication comprising at least one digital certificate from a trusted website locatable by a trusted URL;
(a2) storing said trusted URL as a reference-URL in said reference database, and
(a3) adding the received digital certificate to the set of approved digital certificates associated with said trusted URL.

5. The method of claim 1 wherein step (a) comprises importing contents of an external database into said reference database.

6. The method of claim 1 wherein the alert is issued if said communication is no longer protected by a digital certificate.

7. The method of claim 1, wherein the alert is issued if said communication has a digital certificate issued by a new certification authority that is different from any certification authority that has previously issued a one or more digital certificates to the URL.

8. The method of claim 1, wherein said alert is selected from at least one of a group comprising:
(i) a visual alert for a user of said internet application;
(ii) an audio alert to a user of said internet application;
(iii) an alert issued directly to said internet application;
(iv) an alert issued directly to a plug-in application to said internet application;
(v) an alert issued to a remote internet location;
(vi) an alert issued to a representative of a proprietor of said source-URL.

9. The method of claim 1 wherein said URL verification module is selected from at least one of the group comprising:
(a) a plug-in to a software application;
(b) an add-on software application running on a communication device;
(c) a remote application intercepting communication from a communication device, and
(d) a software application running on at least one remote device selected from the group comprising: a gateway server, a mail server and a proxy server.

10. The method of claim 1 wherein said reference database is further limited by at least one characteristic selected from the group comprising:
(i) at least one said associated set comprising one approved digital certificate;
(ii) said reference database being in communication with a plurality of URL verification modules;
(iii) said reference database being editable by a user of a communications device, and
(iv) said reference database being editable by representatives of the proprietors of said source-URLs.

11. The method of claim 1 wherein said digital certificate comprises a public key certificate.

12. A system for authenticating an internet connection, said system comprising a URL verification module for communicating with a reference database for storing at least one reference-URL and an associated set of approved digital certificates, wherein said verification module provides an alert unless an internet communication received from a source-URL includes at least one digital certificate which is a member of the set of approved digital certificates associated with a reference-URL matching said source-URL.

13. The system of claim 12 wherein said URL verification module is selected from at least one of the group comprising:
(a) a plug-in to a software application;
(b) an add-on software application running on a communication device;
(c) a remote application intercepting communication from a communication device, and
(d) a software application running on at least one remote device selected from the group comprising: a gateway server, a mail server and a proxy server.

14. The system of claim 12 wherein said reference database is further limited by at least one restriction selected from the group comprising:
(i) at least one said associated set comprising one approved digital certificate;
(ii) said reference database being in communication with a plurality of URL verification modules;
(iii) said reference database being editable by a user of a communications device, and
(iv) said reference database being editable by representatives of the proprietors of said source-URLs.

15. The system of claim 12 wherein said digital certificate comprises a public key certificate.

14. A carrier medium carrying computer readable code, said code operable for:
intercepting an internet communication from a source-URL; communicating with a storage medium for storing at least one reference-URL and an associated set of approved digital certificates, and
providing an alert unless the intercepted internet communication comprises at least one digital certificate which is a member of the set of approved digital certificates associated with a reference-URL matching said source-URL.

15. The carrier medium of claim 14 wherein said code is selected from at least one of the group comprising:
(a) a plug-in to a software application;
(b) an add-on software application running on a communication device;
(c) a remote application intercepting communication from a communication device, and
(d) a software application running on at least one remote device selected from the group comprising: a gateway server, a mail server and a proxy server.

16. The carrier medium of claim 14 wherein said storage medium is further limited by at least one characteristic selected from the group comprising:
(a) at least one said associated set comprising one approved digital certificate;
(b) said storage medium being in communication with a plurality of carrier media;
(c) the contents of said storage medium being editable by at least one communications device, and
(d) the contents of said storage medium being editable by representatives of the proprietors of said source-URLs.
